(19) United States
(12) Patent Application Publication
(10) Pub. No.: US 2026/0103917 A1
(43) Pub. Date: Apr. 16, 2026

(54) Luggage Door Paddle Lock Assembly

(71) Applicant: Steiner Enterprises, Lafayette, IN (US)

(72) Inventors: Joshua E. DeWitt, Westfield, IN (US); Thomas P. Hicks, Lafayette, IN (US); Donald E. DeWitt, Syracuse, IN (US)

(21) Appl. No.: 19/357,527

(22) Filed: Oct. 14, 2025

Related U.S. Application Data
(60) Provisional application No. 63/706,290, filed on Oct. 11, 2024.

(51) Int. Cl. E05B 63/14; E05B 15/04; E05C 1/14; E05C 9/20

(52) U.S. Cl. CPC E05B 63/143; E05B 15/04; E05C 1/145; E05C 9/20; E05B 2015/0406

(57) ABSTRACT

A latching system for the compartment door of a vehicle, such as an RV, includes a main latch assembly and one or two follower latch assemblies, providing two or three points of locking engagement between the compartment door and the RV wall. All of the latches, whether two or three or more, are automatically opened in unison by actuation of a single paddle associated with the main latch assembly. A cable is connected between the main latch assembly and the follower latches so that pivoting the paddle of the main latch assembly automatically moves the plunger of all connected latch assemblies to their open configurations.

### REFERENCE TO RELATED APPLICATION

This application claims priority to U.S. provisional application No. 63/706,290, filed on Oct. 11, 2024, the entire disclosure of which is incorporated herein by reference.

### BACKGROUND

Many vehicles, such as recreational vehicles (RVs) include luggage or cargo compartments that are accessible from the outside of the vehicle. In particular, RVs frequently include multiple luggage compartments at the bottom of exterior side walls of the RV. The luggage compartment is often the most used component of an RV, so durability and security are critical features. Most luggage compartment doors include a single key-operated rotary latch that includes a latch bar that is rotated by turning the key to engage or disengage a ledge on the door opening of the compartment. Although rotary latches of this type are inexpensive, they are not as secure as desired for many RV owners. Moreover, the rotary latches of this type cannot be opened form inside the compartment in the event that a person, such as a child, is inadvertently closed in the luggage compartment.

### SUMMARY OF THE DISCLOSURE

The present invention addresses these problems with the prior art rotary latch. In particular, a latching system includes one or two main latch assemblies and one or two follower latch assemblies, providing two or three points of locking engagement between the compartment door and the RV wall. All of the latches, whether two or three or more, are automatically opened in unison by actuation of a single paddle associated with a main latch assembly. A cable is connected between a main latch assembly and all other latches so that pivoting the paddle of the main latch assembly, to move the plunger of the main latch to the open configuration, automatically moves the plunger of all connected latches to their open configurations.

The latching system of the present disclosure is thus operated by lifting one paddle, so that only one opening paddle is visible on the front of the compartment door. Another benefit is that multiple plungers can be distributed along the width of the door to securely lock even the widest RV compartment door.

### BRIEF DESCRIPTION OF THE DRAWINGS

FIG. 1A is view of the interior of a luggage compartment with a latch assembly according to one embodiment of the present disclosure.

FIG. 1B is a view of the exterior of the luggage compartment shown in FIG. 1A.

FIG. 2 is a front perspective view of a main latch assembly according to one embodiment of the latch assembly with the latch in a first closed position.

FIG. 3 is a side cross-sectional view of the main latch assembly shown in FIG. 2.

FIG. 4 is a rear view of the main latch assembly shown in FIG. 2

FIG. 5 is a rear perspective view of the main latch assembly shown in FIG. 4 with the rear cover removed.

FIG. 6 is a rear perspective view of the main latch assembly shown in FIG. 5 with the latch in a second open position.

FIG. 7 is a side cross-sectional view of the main latch assembly shown in FIG. 6.

FIG. 8 is an exploded view of the main latch assembly shown in FIG. 2.

FIGS. 9A-9C are side, rear and rear cut-away views of the paddle and actuator lever of the main latch assembly shown in FIGS. 2-8.

FIG. 10 is a side view of a cable assembly of one embodiment of the latch assembly.

FIG. 11 is a front perspective view of a follower latch assembly according to one embodiment of latch assembly of the present disclosure.

FIG. 12 is a side cross-sectional view of the follower latch assembly shown in FIG. 11.

FIG. 13 is an exploded view of the follower latch assembly shown in FIG. 11.

FIG. 14 is a front perspective view of a main latch assembly according to a further embodiment that includes an emergency lever.

FIG. 15 is a rear perspective view of the main latch assembly shown in FIG. 14.

FIG. 16 is an exploded view of the main latch assembly shown in FIG. 14.

FIGS. 17A, 17B are rear perspective views showing the main latch assembly of FIG. 14 in a closed and an open configuration.

FIG. 18 is a rear perspective view of a follower latch assembly according to a further embodiment of the disclosure that includes an emergency lever.

FIG. 19 is an exploded view of the follower latch assembly of FIG. 18.

FIG. 20 is a rear perspective view of a latch assembly according to another embodiment of the disclosure.

### DETAILED DESCRIPTION

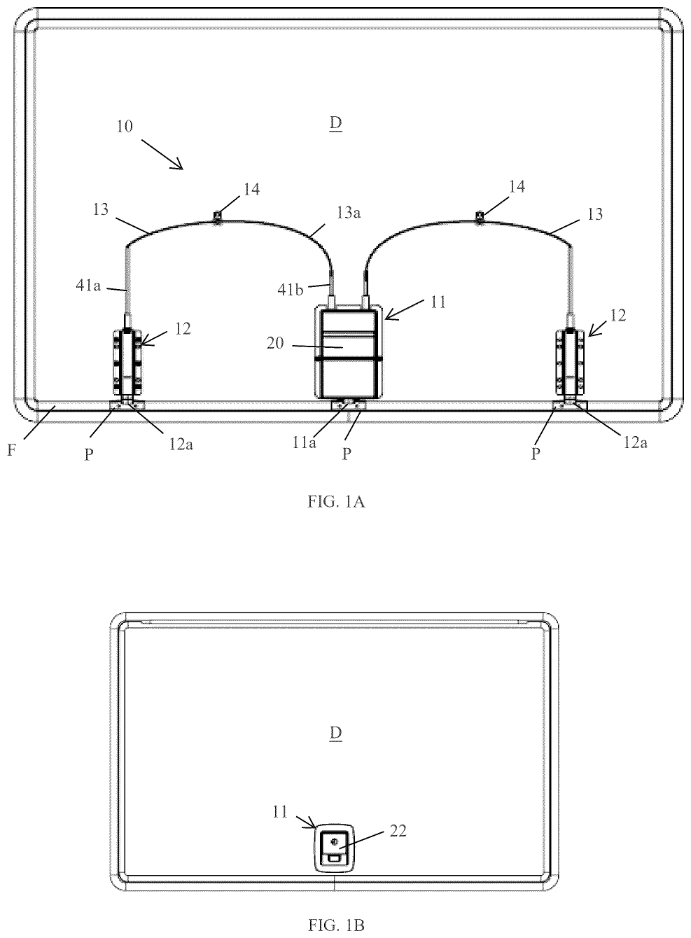

In one embodiment of the present disclosure, a latching system 10 shown in FIGS. 1A-1B is mounted to the door D of a luggage compartment in a vehicle, such as a recreational vehicle (RV) or a fifth-wheel trailer. The latching system 10 includes a main latch assembly 11 with a plunger 11a that is extended and retracted by a main latch mechanism 20 that is mounted on the inside face of the door D, as shown in FIG. 1A. The main latch mechanism 20 is operated by a paddle 22 accessible on the outer face of the door, as shown in FIG. 1B. The latching system also includes two follower latch assemblies 12 that are connected to the main latch mechanism 20 by respective cable assemblies 13. The cables are supported on the inside of the door D by corresponding brackets 14. Each follower latch assembly 11 includes a corresponding plunger 12a.

Each of the plungers 11a, 12a is configured to be extended against a corresponding latching surface on the inside of the frame F of the door, to thereby lock door D to the frame F. Preferably the latching surface is a latch plate P that can be replaced if the surface becomes worn. Thus, when the paddle 22 is in the position shown in FIG. 1B, the latching system 10 is in its locked configuration to lock the compartment door. The user can lift the paddle 22 to actuate the main and follower latch assemblies to retract the plungers 11a, 12a, thereby freeing the door D to be opened. In one embodiment, the plungers 11a, 12a are spring-biased to the locked position, but can be configured as a “slam latch” in which the latching end 11b, 12b of the plunger is beveled to contact and slide against the frame F or latching plate P as the compartment door is closed by the user, to then move the extended, locked position by the biasing spring.

In the embodiment shown in FIG. 1A, the main latch assembly 11 includes a plunger 11a. In an alternative embodiment, the plunger 11a is eliminated, leaving the plungers 12a of the two follower latch assemblies 12 to lock the compartment door. In still other embodiments, such as for a smaller compartment door, the latching system 10 can include one main latch assembly 11 and one follower latch assembly 12. In yet another embodiment, the latching system 10 can include two main latch assemblies 11 connected by a cable assemblies 13, with each main latch having its own paddle 20 that can be optionally operated by the user to open and lock the compartment door.

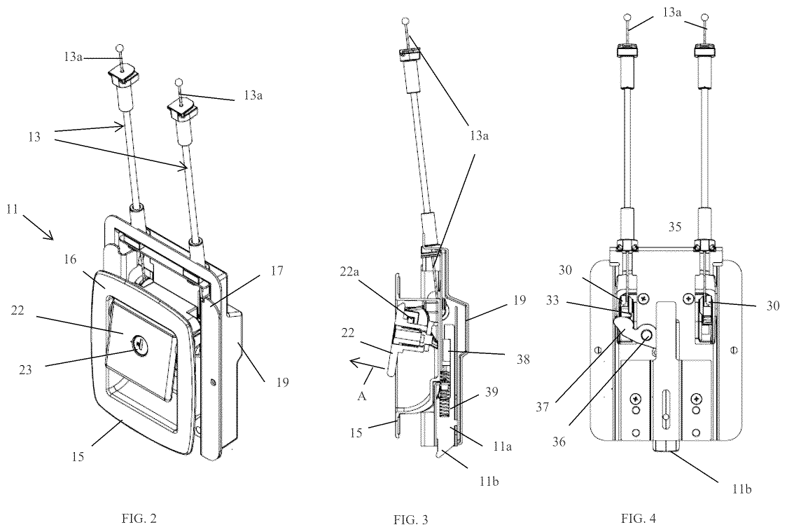

Details of one embodiment of the main latch assembly 11 are shown in FIGS. 2-10. The main 10 includes a paddle housing 15 that pivotably supports the paddle 22 and provides a frame 16 to be fixed at an opening in the compartment door D on the outside of the door. The latch mechanism 20 is housed within a latch housing 17 that is configured to be fixed at the opening in the door D on the inside of the door. The two housings 15, 17 can be configured to interact to fix the main latch assembly in the door D with the main latch 11a oriented so that the latching end 11b will engage a corresponding latch plate P. A cover 19 is provided on the interior of the door to fully enclose the mechanical components of the main latch assembly.

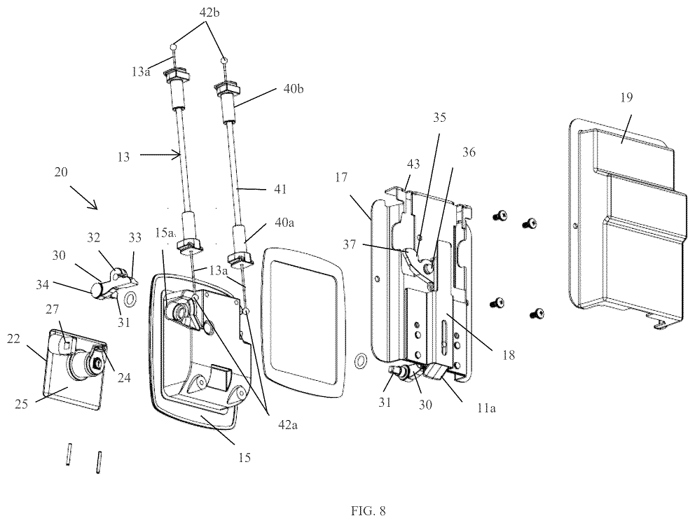

The paddle 22 is pivotably mounted to the paddle housing 15 at a pivot mount 22a so that the paddle can be pivoted outward as indicated by the arrow A in FIGS. 3 and 7. The paddle 22 is shown near the locked position in FIG. 3 and in the fully opened position in FIG. 7. The paddle includes a conventional key lock 23 that can be rotated with a key to rotate a locking tab 24 (FIG. 8) that engages the paddle housing 15 to prevent the paddle 22 from pivoting outward to the position shown in FIG. 7.

The latch housing 17 includes a cable base mount 43 to support the base 40a of a pair of cable assemblies 13. As shown in more detail in FIG. 10, the cable assemblies 13 include a cable base 40a, 40b at the opposite ends of the assembly. The cable bases are connected by a flexible outer sheath 41 so that the cable assembly 13 can be curved as shown in FIGS. 1A-1B to extend from the main latch assembly 11 to each of the follower latch assemblies 12. A flexible cable 13a extends through the cable base and sheath with the free ends of the cable projecting beyond the cable bases 40a, 40b. A ball end 42a, 42b is affixed at each end of the cable 13a. The cable base 40a is configured to be fixed within the cable base mount 43 of the latch housing so that the position of the outer sheath 41 is fixed so that the cable 13a can slide within the sheath. In the illustrated embodiment, two cable assemblies 13 are provided to connect the main latch assembly 11 to two follower latch assemblies 12. It is contemplated that the outer sheath 41 extends along the entire length of the cable 13a between the latch assemblies. In another embodiment, as depicted in FIG. 1, the sheath is provided in two segments 41a, 41b associated with the latch assemblies connected by the cable 13a. In this embodiment, the sheath segments 41a, 41b only support the cable at its opposite ends, leaving the middle portion of the cable free. The brackets 14 support the middle portion and can include a bushing to facilitate the sliding movement of the cable 13a through the bracket.

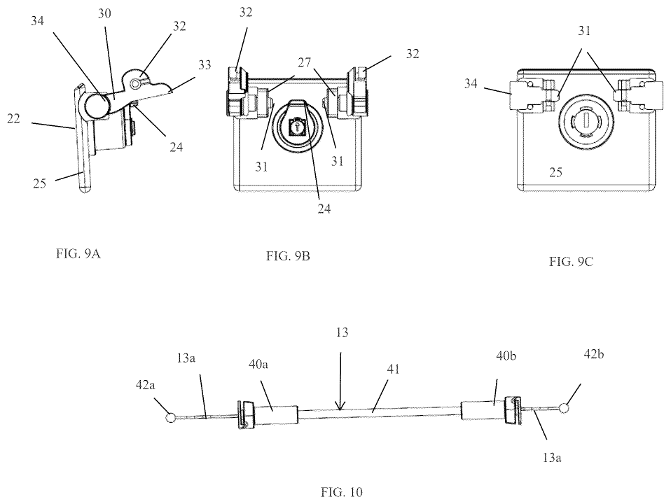

The cable 13a is engaged to an actuator lever 30 via a ball receiver 32 that holds the ball end 42a of the cable. As best seen in FIGS. 8, 9A, the lever 30 includes a mounting post 31 that is engaged to a lever mount 27 on the inside face of the paddle plate 25 of the paddle 22. The mounting post 31 is fixed to the lever mount 27 so that the lever pivots with the paddle 22. The lever defines a bearing support 34 that is seated within a notch 15a in the paddle housing 15 (FIG. 8). As shown in FIGS. 9B-9C, two levers 30 are provided that are engaged to two lever mounts 27 on opposite sides of the paddle 22. The bearing support 34 of each lever is seated within a corresponding notch 15a on opposite sides of the paddle housing 15, so that the bearing supports pivotably support the paddle 22 within the housing 15.

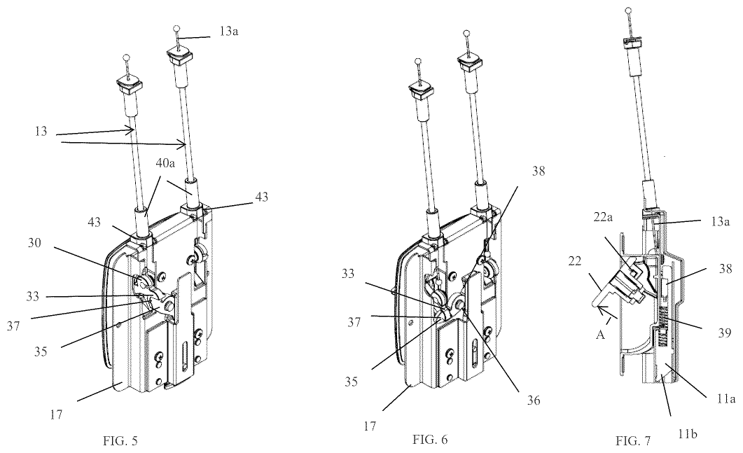

Each lever 30 includes an extension 33 at the inboard end of the lever. The extension 33 is arranged to contact a plunger lever 35, as shown in FIG. 4-6. The plunger lever 35 is pivotably mounted to the rear face of the latch mechanism housing 17 by a pivot post 36. The actuator lever 30 contacts an actuator end 37 of the plunger lever 35 so that as the actuator lever pivots, it causes the plunger lever 35 to pivot about the pivot post 36. When the paddle 22 is in its closed position shown in FIGS. 3-5 the extension 33 is angled upward, and when the paddle is pivoted upward to its open position shown in FIGS. 6-7, the extension 33 is angled downward. In the closed position, the upward angle of the extension 33 allows the actuator end 37 of the plunger lever 35 to pivot upward about the pivot pin 36. The plunger lever 35 is engaged to the plunger 11a at plunger end 38 on the opposite side of the pivot pin from the actuator end 37. Thus, when the actuator end 37 is pivoted upward, the plunger end 38 is pivoted downward, and when the actuator end is pivoted downward, the plunger end is pivoted upward. When the plunger end 38 pivots upward, it pulls the plunger 11a upward against a biasing spring 39 so that the plunger is retracted into the plunger support frame 18 (FIG. 8). Thus, the plunger disengages the latch plate P allowing the door D of the compartment to be opened.

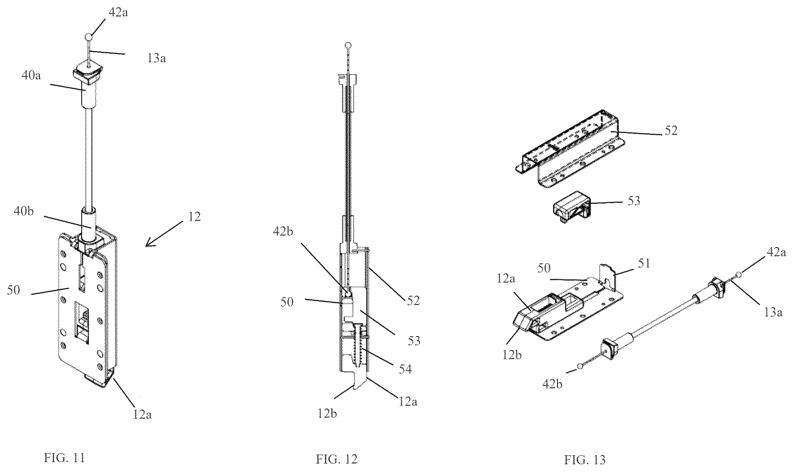

When the paddle 22 is pivoted upward and the actuator lever 30 pivots downward, the ball receiver 32 moves downward, thereby pulling the cable 13a due to the engagement of the ball end 42a within the ball receiver. The cable base 40a holds the support sheath 41 in position so that the cable 13a can move relative to the sheath, thereby pulling the ball end 42b at the opposite end of the cable 13a. The opposite ball end 42b is connected to a follower latch assembly 12, as shown in FIGS. 11-13. The follower latch assembly 12 is carried by a follower frame 50 that is fastened to the inside of the door D (FIGS. 1A-1B) and is slidably held by a housing 52. The cable base 40b of the cable assembly 13 is mounted on a base mount 51 of the frame 50 with the ball end 52b extending into the housing. The ball end 42b is engaged within a ball receiver 53 that is attached to the plunger 12a. Thus, upward movement of the ball end 42b pulls the plunger 12a upward, so that the latching end 12b disengages the latch plate P allowing the door D of the compartment to be opened. The plunger includes a biasing spring 54 that biases the latching end 12b into the closed position.

In the illustrated embodiment, the main latch assembly 11 includes a plunger 11a for engaging a corresponding latching plate P of the compartment. Alternatively, the main latch assembly does not include the plunger 11a, and therefore does not include the plunger lever 35. In this instance, the actuator levers 30 on either side of the paddle 22 are still connected to the follower latch assemblies 12 by corresponding cable assemblies 13.

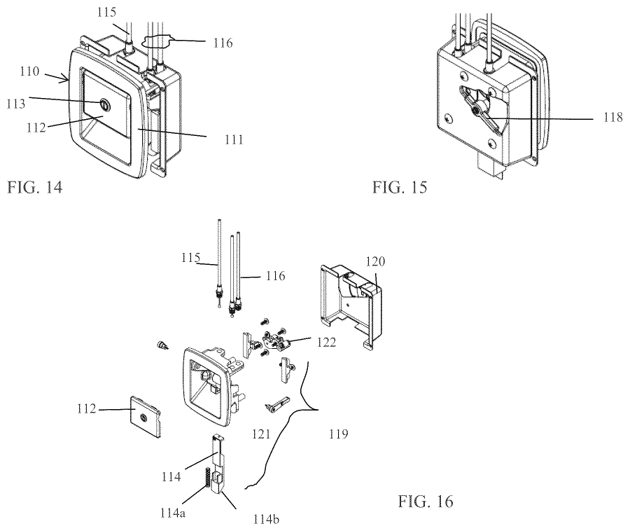

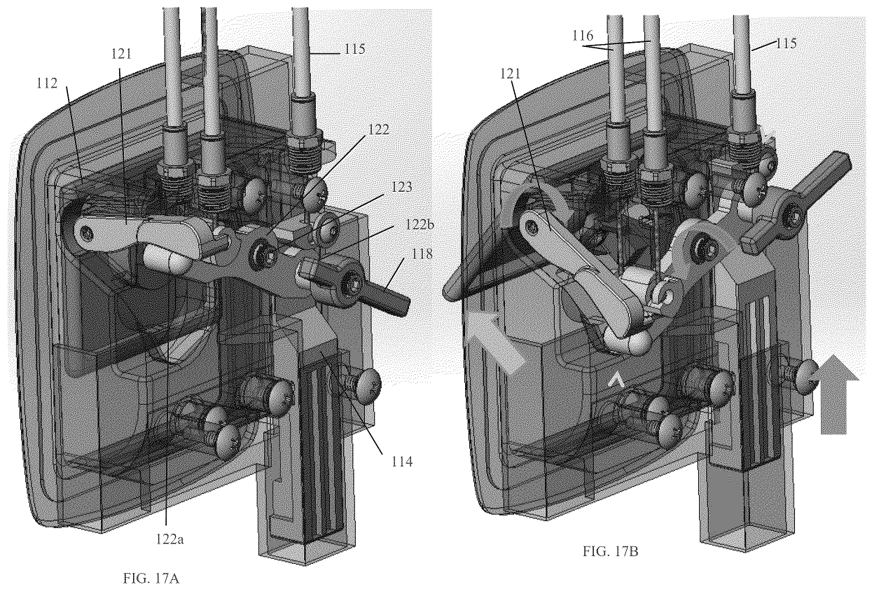

A main latch assembly according to a further embodiment is shown in FIGS. 14-17B. The main latch assembly 110 includes a frame 111 that is embedded within the luggage door. The paddle 112 is pivotably mounted within the frame and includes a key lock 113. The latch includes a plunger 114 that moves vertically within the frame 111 to engage a receptacle in the RV wall and that is biased by a spring 114a to an extended position. The plunger includes a beveled tip 114b so that the plunger can be slammed into engagement with the locking receptacle of receptacle frame in the RV wall. A transfer mechanism 119 is connected between the paddle 112 and the plunger 114 to lift the plunger when the paddle is pivoted upward. The mechanism 119 is also connected between the paddle and the cable assemblies 115, 116 to pull the cables when the paddle is pivoted upward. The cable assemblies are configured like the cable assembly 13. The cable assembly 115 can connect the main latch assembly 110 to another identically configured main latch assembly. The cable assemblies 116 can connect the main latch assembly 110 to one or two follower latch assemblies.

As best shown in FIGS. 17A-17B, the mechanism 19 includes an actuator lever 121 that is connected to the paddle 112 to pivot with the paddle. The actuator lever 121 contacts actuator end 122a of a plunger lever 122 that is connected to the plunger 114 at end 122b. The plunger lever 122 pivots about a pivot mount 123 so that when actuator end 122a is forced down by the actuator lever 121, the end 122b pivots upward, thereby pulling the plunger upward.

In a further feature, the main latch assembly 110 includes an emergency lever 118 that is accessible outside the housing 120 enclosing the main latch components, from inside the luggage compartment. The emergency lever is connected to the end 122b of the plunger lever 122 to acuate and release all of the latches when the emergency lever is rotated upward.

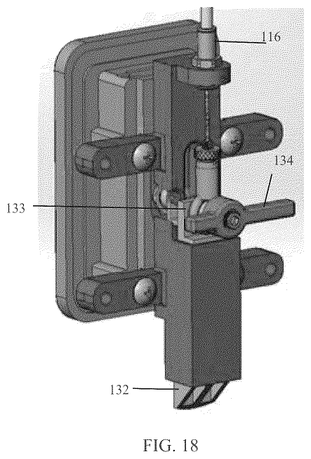

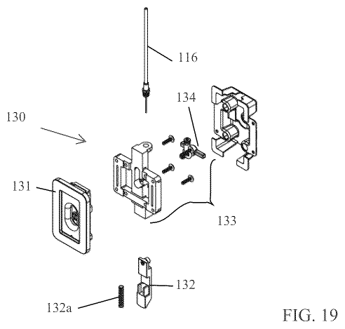

A follower latch assembly 130 is shown in FIGS. 18-19. The follower latch assembly includes a face plate 131 that can either be fully closed, or can include an opening to receive a key lock. The slam latch includes a plunger 132 that is spring-biased by spring 132a to the extended or locked position. The plunger includes a beveled tip 132a so that the plunger can be slammed into engagement with receptacle frame. A transfer mechanism 133 contained within the latch housing 134 connects the plunger 132 to the cable 116, which cable is connected to the main latch assembly 110. Pulling the cable upward, when the main latch paddle is actuated, in turn pulls the plunger 132 upward to release the latch. The latch also includes an emergency lever 134 that is connected to the plunger 132 to release the latch without using the paddle of the main latch assembly.

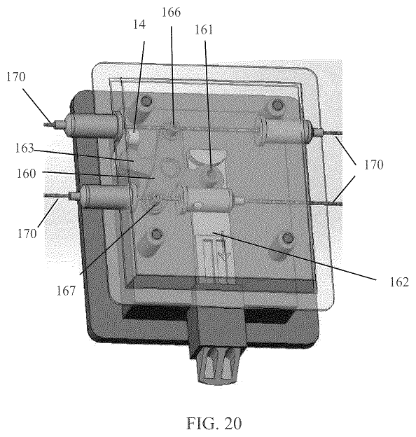

FIG. 20 shows an alternative latch mechanism that can serve as either a main latch assembly or as a follower latch assembly depending on the cables that are connected to the transfer mechanism. In this embodiment, the transfer mechanism includes a X-shaped rotating lever 160. One arm 161 of the lever engages the plunger 162 to pull the plunger upward when the X-shaped lever is rotated in the counter-clockwise direction. The opposite arm 163 is pushed downward by a lever 164 connected to the paddle 165 of the latch, to thereby rotate the X-shaped latch in the counter clockwise direction. The vertical arms 166, 167 are connected to cables 170 that are connected to other similar latches that are configured solely as a follower latch assembly, such as the latch shown in FIG. 18. Rotation of the X-shaped lever actuates the other latches.

What is claimed is:

1. A latching system for a compartment door of a vehicle, the door including a frame defining a number of latching surfaces, the latching system comprising:
a main latch assembly including;
a main housing mounted to the compartment door;
a paddle pivotably mounted in the main housing so that the paddle can pivot between a closed position and an open position, the paddle accessible from the outside of the compartment door; and
at least one latching lever fastened to the paddle to pivot with the paddle and including a main ball mount;
at least one follower latch assembly including;
a follower housing mounted to the inside of the compartment door; and
a plunger slidably disposed within said follower housing, the plunger including;
a latching end configured to engage one latching surface of the number of latching surfaces when the plunger is in a locking configuration and to disengage the one latching surface when the plunger is in an open configuration; and
a follower ball mount; and
at least one cable assembly corresponding to each follower latch assembly of the at least one follower latch assembly, each cable assembly including;
a flexible sheath having a cable base at opposite ends of the sheath, one cable base mounted to the main housing and the other cable base mounted to the follower housing to fix the at least one cable assembly between the main and follower housings; and
a flexible cable slidably extending through said flexible sheath and having a ball end at the opposite ends of the cable, one ball end disposed in the main ball mount and the other ball end disposed in the follower ball mount,
whereby, when the paddle is pivoted to the open position, the latching lever pivots and the main ball mount pulls the flexible cable, and the cable pulls the follower ball mount to move the plunger to the open configuration.

2. The latching system of claim 1, wherein said main latch assembly further includes:
an extension on one lever of the at least one latching lever;
a main plunger slidably disposed within said main housing and including a latching end configured to engage one latching surface of the number of latching surfaces when the plunger is in a locking configuration and to disengage the one latching surface when the plunger is in an open configuration; and
a plunger lever having an actuator end in engagement with said extension of said one lever, a plunger end connected to said main plunger and a pivot mount between said actuator end and said plunger end to pivotably mount said plunger lever to said main housing,
wherein said actuator lever and said plunger lever are arranged so that when the latching lever pivots with said paddle when the paddle is pivoted to the open position the actuator lever pushes the actuator end of the plunger lever to pivot the plunger end to move the main plunger to the open configuration.

3. The latching system of claim 2, wherein said main latch assembly includes an emergency lever accessible outside said main housing on the inside of the compartment door, said emergency lever coupled to said plunger lever to move the plunger lever to the open position independent of the paddle.

4. The latching system of claim 1, wherein:
the main latch assembly includes two latching levers;
the at least one follower latch assembly includes two follower latch assemblies; and
the at least one cable assembly includes two cable assemblies, one cable assembly connected between a corresponding latching lever and corresponding follower latch assembly.

5. The latching system of claim 4, wherein said two latching levers are fastened to opposite sides of said paddle.

6. The latching system of claim 5, wherein:
each latching lever includes a bearing support; and
said main housing defines two notches in said main housing, wherein each bearing support is pivotably received within a corresponding notch to pivotably mount said paddle in the main housing.

7. The latching system of claim 1, further comprising a bracket corresponding to each of said at least one cable assembly, said bracket fastened to the inside of the compartment door between said main latch assembly and a corresponding one of said at least one follower latch assembly.

8. The latching system of claim 1, wherein said plunger includes a biasing spring to bias said plunger with the latching end in engagement with the one latching surface.
